(19) United States
(12) Patent Application Publication
(10) Pub. No.: US 2010/0082401 A1
(43) Pub. Date: Apr. 1, 2010

(54) FORECASTING FOR ADVERTISING INVENTORY ALLOCATION

(75) Inventors: Erik Vee, San Mateo, CA (US); Ramana Yerneni, Cupertino, CA (US); Jayavel Shanmugasundaram, Santa Clara, CA (US); Sergei Vassilvitskii, New York, NY (US); Srinivasan Rajagopal, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/240,749

(22) Filed: Sep. 29, 2008

(51) Int. Cl. G06Q 30/00; G06Q 90/00

(52) U.S. Cl. 705/10; 705/14.73

(57) ABSTRACT

Subject matter disclosed herein relates to a system for managing online advertising, and in particular, to pricing of advertising inventory and its allocation to advertising campaigns.

### BACKGROUND

1. Field

Subject matter disclosed herein relates to a system for managing online advertising, and in particular, to pricing of advertising inventory and its allocation to advertising campaigns.

2. Information

A technique for advertising on the Internet may include matching a targeted advertising campaign with Internet users that may be most likely interested in such advertising. For example, if an auto manufacturer is launching a new product, a preferred Internet audience may be one that visits Internet sites featuring automobiles. Though such advertiser-audience alignment is apparent in this example, in actual practice such an alignment may be much more complex.

Information regarding an Internet user may be obtained as the user navigates through multiple Internet sites, for example. Such a user may also have submitted personal data if enrolling into an online account for email, a chat site, an Internet group, and so on. A page view, or impression, open to such a user may present an opportunity for an advertisement.

Upon establishing one or more advertising campaigns, an advertising system may decide whether it is feasible to deliver a desired number of advertising opportunities that match an advertising campaign target profile, for example. Such an advertising system may also set a price for advertising opportunities that match an advertising campaign target profile. Such a decision may, for example, be similar to a decision regarding a reservation system that considers a request and decides whether there is adequate supply to satisfy the request. However, unlike a general reservation system where a decision may be based on a relatively simple count of available inventory, decisions may be relatively difficult in an advertising system because inventories of advertising opportunities satisfying advertising campaigns may intersect in complex ways. Deciding how to apportion such intersecting inventories of advertising opportunities to various advertising campaigns may involve a combinatorial problem requiring a relatively large amount of time to solve, especially as the number of advertising campaigns grows. Accordingly, in an advertising system, it may be difficult to optimally decide pricing and allocating of advertising opportunities to advertising campaigns.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a diagram illustrating advertising campaigns and associated advertising opportunities, according to an embodiment.

FIG. 2 is a flow diagram of an online advertising allocation process, according to an embodiment.

FIG. 3 is a flow diagram of an online advertising allocation and price determination process, according to an embodiment.

FIG. 4 is a schematic diagram of a system for allocating advertising inventory, according to an embodiment.

FIG. 5 is a schematic diagram illustrating an embodiment of a computing system.

### DETAILED DESCRIPTION

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing node, such as a computer or a similar electronic computing device, that manipulates and/or transforms data represented as physical electronic and/or magnetic quantities within the computing node's memories, registers, and/or other information storage, transmission, and/or display devices.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In an embodiment, a supply of advertising opportunities may be allocated to a set of advertising campaigns that are capable of consuming or using such advertising opportunities. In a particular embodiment, an advertising opportunity may include a page view in a Web advertising system, a page view resulting from an Internet search, an Internet marketing site, and/or an email account, just to name a few examples. The Internet may provide multiple opportunities to specifically advertise to a particular target audience. For example, an advertiser may advertise airline tickets to a Web user searching the Internet for Hawaii vacation. In contrast, traditional advertising media, such as television, radio, and/or newspaper, for example, may not enable an advertiser to advertise to such a particular audience. Quantities of advertising opportunities may be regarded as advertisement inventories. An advertising campaign may include a process of advertising directed to a particular target audience. For example, an advertiser may engage in an advertising campaign to advertise a particular product to a particular group of consumers that are most likely to have an interest in purchasing the product, although claimed subject matter is not limited to such an example. In a particular example, an auto manufacturer of an expensive sports car may engage in an advertising campaign to advertise to young drivers having a relatively high income.

Multiple advertising campaigns may compete for an inventory of advertising opportunities. Such a competition or contention among multiple advertising campaigns may occur if target audiences for such advertising campaigns overlap. For example, an advertising campaign may target males between the ages of 20 and 30, while another campaign may target Californians between the ages of 25 and 35. Thus, a determination of how to allocate a supply of advertising opportunities to contending advertising campaigns may involve a relatively complicated analysis. In particular, given a set of advertising opportunities and a set of advertising campaign targets, an allocation problem may involve allocating advertising opportunities to advertising campaigns in such a way that individual advertising campaigns may be allocated advertising opportunities that they request. Accordingly, a solution to such an allocation problem may be used to allocate advertising opportunities to advertising campaigns. In a particular embodiment, such a problem may be solved relatively quickly online for a relatively large set of advertising opportunities and a relatively large set of advertising campaigns, as discussed below.

In an embodiment, an online advertising campaign may specify demographics of one or more Internet users; a quantity of the one or more Internet users; and a time period for which the online advertising campaign is to target the one or more Internet users. For example, an Internet user profile may include user demographics, geographic location of the user, the user's internet searches and behavior, and/or content context of Internet sites that the user may visit. Of course, these are merely examples of elements of an online advertising campaign, and claimed subject matter is not so limited.

In an embodiment, advertisement inventory may be allocated to an online advertising campaign based on demand resulting from the online advertising campaign. Such an allocation may be based on, for example, a greedy algorithm, so that the online advertising campaign may be allocated quantities of inventory that it requests. In a particular embodiment, pricing for advertisement inventory may be determined based, at least in part, on a forecasted future demand for advertisement inventory, as will be explained below. Accordingly, advertisement inventory may be priced for an allocation to a current online advertising campaign based, at least in part, on such a forecasted future demand. Such pricing may reflect an opportunity cost of utilizing an advertising opportunity and/or advantage to sell advertisements at an increased price, for example. Of course, such processes of allocating advertisement inventory are merely examples, and claimed subject matter is not so limited.

In an embodiment, an advertising allocation system may forecast a demand for advertisement inventory. Such a demand may be directed to an online advertising campaign, for example. Here, an online process may refer to a real-time process and/or a process involving a network connection such as the Internet. Forecasting such a demand may include modeling the demand in such a way as to enable an assessment of available advertisement inventory. In one particular embodiment, such an assessment may be used to allocate at least a portion of available advertisement inventory to an online advertising campaign. In particular, such an online advertising campaign may include a current online advertising campaign. Such a current online advertising campaign may be associated with an advertiser that has a pending, as-yet unfulfilled request for advertisement inventory. In another particular embodiment, an assessment of future demand for available advertisement inventory may be used to allocate at least a portion of available advertisement inventory to an online advertising campaign. Such a future demand for available advertisement inventory may result from one or more future advertising campaigns, which may be campaigns that do not currently exist, but may be part of a forecast model. As mentioned above, an assessment of available advertisement inventory and pricing may be provided by such forecast modeling or by forecasting future demand for available advertisement inventory.

Forecasting or modeling a demand for advertisement inventory may include determining demographic, geographic, and/or behavioral information corresponding to an online advertising campaign. Using such information, a forecasted demand may be determined by analyzing trends of the demographic, geographic, and/or behavioral information. For example, an online advertising campaign may target California males between the ages of 25 and 35. Analyzing trends of such demographic, geographic, and/or behavioral information may provide an assessment of advertisement inventory. Accordingly, having an assessment of current online advertising campaigns, forecasting or modeling a demand for advertisement inventory may be realized.

In an embodiment, forecasting future demand for advertisement inventory may include defining future online advertising campaigns. Defining one or more future online advertising campaigns may involve, for example, predicting a likelihood that such campaigns will occur in a future time span. Each particular campaign may be defined having an associated particular time span. Advertising target profiles corresponding to predicted future advertising campaigns may provide information to forecast a demand for advertisement inventory presented by one or more of the future online advertising campaigns. The advertising target profiles may include demographic, geographic, and/or behavioral information regarding a target audience for a particular future advertising campaign, for example. Such profiles may also include quantities of particular advertisement inventory that may be requested by future advertising campaigns.

In an embodiment, a page view, or impression, may present an opportunity for an advertisement. Such an impression may include a webpage viewed by an Internet user associated with demographic, geographic, and/or behavioral characteristics that match a target profile of an online advertising campaign, for example. In a particular embodiment, an advertising allocation process may include determining one or more such impressions that match respective target profiles of online advertising campaigns. Next, an inventory may be determined for individual impressions. From determined inventory, a portion of such impressions may be allocated to previous online advertising campaigns. Such a portion may leave a remaining portion that may be allocated to a current online advertising campaign, for example.

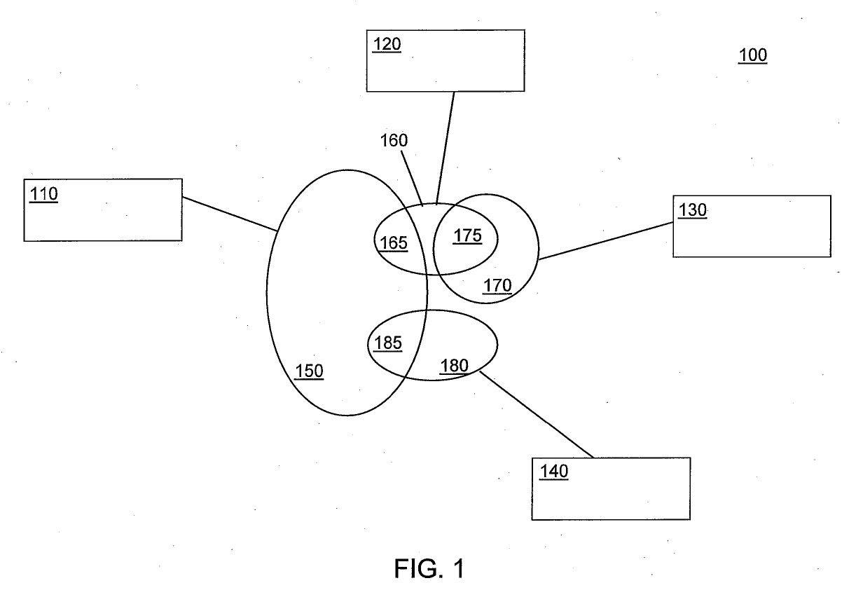

FIG. 1 is a diagram illustrating a sample of advertising campaigns and associated advertising opportunities, according to an embodiment. Such a sample 100 may include advertising campaigns 110, 120, 130, and 140 and associated advertising opportunities 150, 160, 170, and 180, respectively. An advertising campaign may include one or more processes initiated by an advertiser to provide information (e.g., an advertisement) to an audience targeted by virtue of their apparent interests. Apparent interests may be described in terms of criteria for a particular advertising campaign, for example. Such an audience may be associated with advertising opportunities, which may include websites, for example, visited by a target audience.

To illustrate, advertising campaign 110 may define criteria that are substantially matched by advertising opportunity 150, which may include a set of advertising opportunities. In other words, advertising opportunity 150 may include targets that correspond to advertising campaign 110. However, a portion, or subset, of advertising opportunity 150 may also match advertising campaigns 120 and 140. For example, a subset 165 of advertising opportunity 160 may overlap with advertising opportunity 150. Such an overlap 165 among advertising opportunities may represent a contention among advertising campaigns 110 and 120. In other words, advertising campaigns 110 and 120 may be interested in the same inventory, or subset 165, of advertising opportunities. Accordingly, an allocation component may determine an allocation of advertisement inventory by considering such contention among advertising campaigns, as described below. Other contention subsets shown in FIG. 1 include overlap 175 among advertising campaigns 120 and 130 and overlap 185 among advertising campaigns 140 and 110.

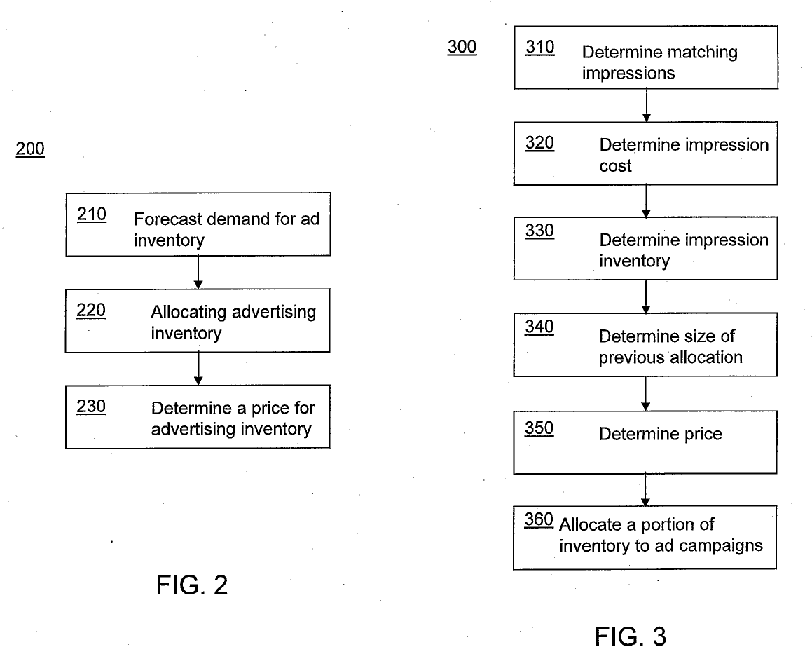

FIG. 2 is a flow diagram of an online advertising allocation process 200, according to an embodiment. At block 210, demand for advertisement inventory resulting from an online advertising campaign may be forecasted. Advertisement inventory may include quantities of advertising opportunities corresponding to a target profile of an online advertising campaign, for example. Demand for such advertisement inventory may be forecasted by considering advertisement inventory in terms of quantities of advertising that an online advertising campaign requests. Of course, such a process of forecasting demand is merely an example, and claimed subject matter is not so limited.

In one particular implementation, advertisement inventory may be allocated to an online advertising campaign based on demand resulting from the online advertising campaign. Such an allocation may be based on, for example, a greedy algorithm, wherein an online advertising campaign may be allocated quantities of inventory that it requests. However, in an embodiment, inventory pricing may be determined by considering a forecasted future demand for advertisement inventory, such a demand being based on advertising campaigns that may not yet exist, for example. In this manner, pricing may be established for advertisement inventory that is allocated to a current online advertising campaign. Accordingly, at block 220, a portion of advertisement inventory may be allocated to the online advertising campaign based, at least in part, on a forecasted future demand for the advertisement inventory. For example, consider a case where an advertising campaign may request to target one million California males. An advertising allocation process that includes a greedy algorithm may allocate enough advertisement inventory to satisfy the advertising campaign's request. On the other hand, as in block 230, a price of advertisement inventory may be established for the online advertising campaign based on a forecasted future demand for the advertisement inventory. Of course, such allocation processes are merely examples, and claimed subject matter is not so limited.

FIG. 3 is a flow diagram of an online advertising allocation and price determination process 300, according to an embodiment. At block 310, such a process may include determining one or more impressions that match an online advertising campaign. Such a campaign may correspond to a contract, which may involve an advertiser's request to target particular demographics over a particular time period, for example. Such a contract may also involve an agreement to allocate a particular quantity of impressions that match the advertiser's target. In one particular embodiment, a process may include determining a sample of impressions that match an online advertising campaign. Such a sample may comprise a portion of a larger number of impressions that may be representative of impressions matching an online advertising campaign.

At block 320, process 300 may include determining a cost for a sample of impressions, such as sample impressions determined at block 310. A cost may include a shadow price and/or an opportunity cost, for example. In a particular implementation, shadow cost may represent an additional cost that represents a competition/contention among various campaigns for a particular advertising opportunity. An opportunity cost may represent advertising alternatives that can fetch monetary benefits, such as utilizing an advertising opportunity to sell advertisements in another arena, for example. At block 330, process 300 may include determining an inventory, or supply, for the sample of impressions. At block 340, process 300 may include determining a size of a first portion of inventory previously allocated to previous online advertising campaigns. At block 350, a price for the sample of impressions may be determined based, at least in part, on the cost and inventory discussed above. At block 360, a second portion of inventory, excluding the first portion of impression inventory previously allocated to previous online advertising campaigns, may be allocated to the online advertising campaign. A price determined at block 320 may be applied to impressions included in the second portion of inventory, for example. Of course, such an allocation and pricing process is merely an example, and claimed subject matter is not so limited.

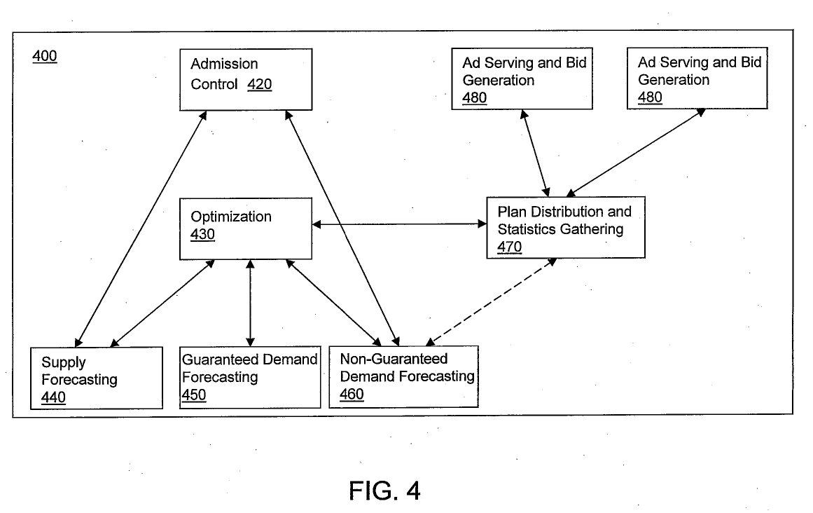

FIG. 4 is a schematic diagram of a system 400 for allocating advertising inventory, according to an embodiment. An admission control component 420 may interact with sales persons, for example, that sell guaranteed contracts to advertisers. Using admission control component 420, a sales person may issue a query to system 400 with a specified target. For example, such a query may include Internet users that browse a finance website and are California males who like sports and autos. Admission control component 420 may return information regarding available advertising inventory for the target and an associated price. The sales person may then book a contract with the advertiser accordingly. An ad server component 480 may receive an opportunity, which may include a user, the context of the user, a webpage visited by the user, and/or other targeting attributes, and return a guaranteed advertisement for the opportunity. Ad server component 480 may also return a price that system 400 is willing to bid for the opportunity. Of course, such a contract querying/booking process and advertisement serving process is merely an example, and claimed subject matter is not so limited.

In an embodiment, a process of system 400 may include an optimization component 430 that may operate offline to reexamine advertising campaigns that were accepted earlier by admission control component 420. Optimization component 430 may provide a solution to an optimization problem to admission control component 420, as explained below. Such a solution may be used by admission control component 420 to update initial conditions to refine an online process, for example.

In an embodiment, optimization component 430 may from time-to-time receive a forecast of advertising supply, or future impressions, from supply forecasting component 440, for example. Additionally, optimization component 430 may also receive information regarding guaranteed advertising demand (expected guaranteed contracts) from guaranteed demand forecasting component 450, and also receive information regarding non-guaranteed demand (expected bids in a spot market, for example) from non-guaranteed demand forecasting component 460. Optimization component 430 may match advertising supply to demand using an overall objective function, which may consider forecasts of advertising supply, guaranteed advertising demand, and non-guaranteed demand. For example, goals of an objective function may include preserving as many high-value impressions/advertising opportunities as possible for future campaigns, minimizing the number of under-allocated campaigns, and/or ensuring that campaigns get a uniform and representative allocation of advertising opportunities that satisfy their specified target. The optimization component 430 may then send a summary plan of an optimization result to admission control component 420 and to a plan distribution and statistics gathering component 470. Such a summary plan of an optimization result may be referred to as a solution to an optimization problem, for example. Plan distribution and statistics gathering component 470 may then send such a solution to individual ad server components 480. The solution to the optimization problem provided by optimization component 430 may be updated from time-to-time and/or periodically, such as every few hours or so, based at least in part on availability of new estimates for advertising supply, demand, and delivered impressions.

To illustrate an embodiment, admission control component, such as admission control component 420 in FIG. 4, may operate as follows. If a sales person issues an advertising target query for some duration in the future, system 400 may invoke a supply forecasting component 440 to determine how much inventory may be available for the particular target and duration, for example. In a particular embodiment, targeting queries may be fine-grained, that is such queries may include a relatively high refinement of advertising targets that include a relatively large number of details. Accordingly, such targeting queries may be in a relatively high-dimensional space, so supply forecasting component 440 may use a scalable multi-dimensional database indexing technique, such as bit-map indices, to capture and store correlations between different targeting attributes, for example. However, capturing correlations among targeting attributes may only be one part of an optimization problem. Another part may involve contentions, e.g., a competition, between multiple contracts. For example, two such competing contracts may include finance webpage users who are California males and general webpage users who are aged 20-35 and interested in sports. In such a case, a solution to an optimization problem may include a determination of how many impressions match contracts associated with each competing contract so that double-counting advertising inventory is avoided. In order to deal with such a contention in a high-dimensional space, supply forecasting component 440 may produce impression samples instead of merely providing available advertising inventory counts. In this fashion, samples of impressions may be used to determine how many contracts may be satisfied by each impression. Given such impression samples, admission control component 420 may use a solution to an optimization problem provided by optimization component 430 to calculate a contention between contracts in a high-dimensional space, and provide information regarding available inventory to sales persons without double-counting, for example. In addition, admission control component 420 may determine a price for individual contracts and quantities of available impressions and provide such information to a sales person. Of course, such a contract querying/booking process is merely an example, and claimed subject matter is not so limited.

Given a solution to an optimization problem, an ad server component, such as ad server component 480 in FIG. 4, may operate according to an embodiment as follows. If an advertising opportunity is presented, ad server component 480 may calculate the contention among multiple contracts for an impression in a process similar to that of admission control 420. Ad server component 480 may be provided with such contention information and knowledge about non-guaranteed demand. Accordingly, ad server component 480 may select an advertising contract and generate a bid for the contract, both which may be sent to an exchange (not shown) to compete with other non-guaranteed contracts.

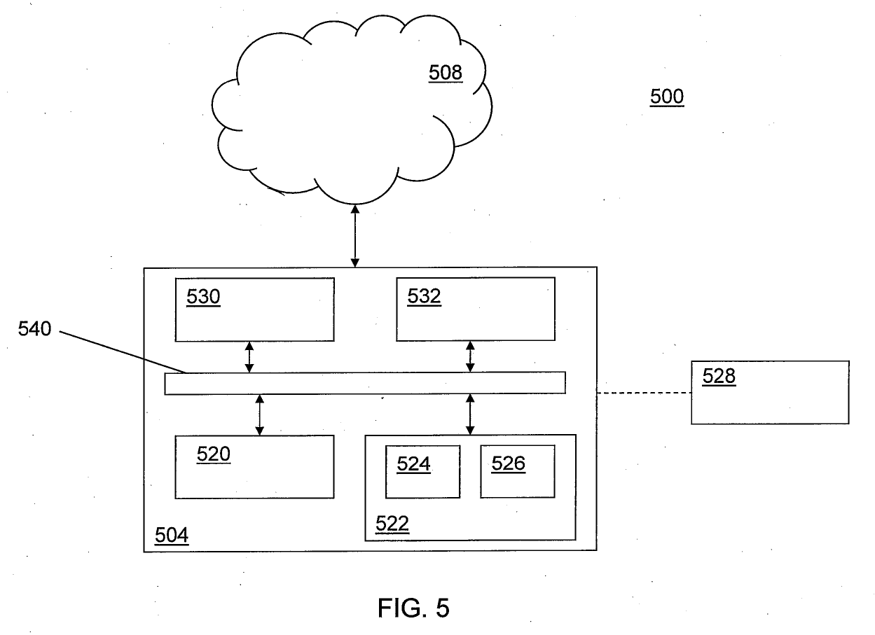

FIG. 5 is a schematic diagram illustrating an exemplary embodiment of a computing system 500 that may include one or more devices configurable to process advertising allocation, such as online advertising allocation using one or more techniques illustrated herein, for example. Computing device 504, as shown in FIG. 5, may be representative of any device, appliance or machine that may be configurable to exchange data over network 508. By way of example but not limitation, computing device 504 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support exchange of information between computing device 504 and other devices (not shown) connected to network 508. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 500, and the processes and methods as further described herein, may be implemented using or otherwise include hardware, firmware, software, or any combination thereof. Thus, by way of example but not limitation, computing device 504 may include at least one processing unit 520 that is operatively coupled to a memory 522 through a bus 540. Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 528. Computer-readable medium 528 may include, for example, any medium that can carry and/or make accessible data, code and/or instructions for one or more of the devices in system 500.

Computing device 504 may include, for example, a communication interface 530 that provides for or otherwise supports the operative coupling of computing device 504 to at least network 508. By way of example but not limitation, communication interface 530 may include a network interface device or card, a modem, a router, a switch, a transceiver, and the like.

Computing device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 532 may include an operatively configured display, speaker, keyboard, mouse, trackball, touch screen, data port, etc.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method via a computer platform, the method comprising:
forecasting demand for advertisement inventory directed to an online advertising campaign; and
allocating at least a portion of said advertisement inventory based, at least in part, on a forecasted future demand for said advertisement inventory.

2. The method of claim 1, further comprising:
allocating said at least a portion of said advertisement inventory to said online advertising campaign.

3. The method of claim 1, further comprising:
pricing said at least a portion of said advertisement inventory based, at least in part, on said forecasted future demand; and
allocating said at least a portion of said advertisement inventory to one or more forecasted advertising campaigns.

4. The method of claim 1, wherein forecasting said demand for said advertisement inventory comprises:
forecasting a demand for said advertisement inventory presented by said online advertising campaign, wherein said online advertising campaign comprises a current online advertising campaign.

5. The method of claim 1, wherein forecasting said demand for said advertisement inventory comprises:
determining demographic, geographic, and/or behavioral information corresponding to said online advertising campaign; and
forecasting said demand by determining a trend using said demographic, geographic, and/or behavioral information.

6. The method of claim 1, wherein forecasting said future demand for said inventory comprises:
defining future online advertising campaigns; and
forecasting a demand for said inventory presented by one or more of said future online advertising campaigns.

7. The method of claim 1, further comprising:
determining a price for said at least a portion of said advertisement inventory.

8. The method of claim 7, wherein determining said price comprises:
determining one or more impressions that match said online advertising campaign;
determining a cost for said one or more impressions;
determining an inventory for said one or more impressions;
determining a size of a first portion of said inventory previously allocated to previous online advertising campaigns;
determining said price based, at least in part, on said cost and said inventory; and
allocating a second portion of said inventory, excluding said first portion, to said online advertising campaign, wherein said price is associated with said second portion.

9. The method of claim 8, wherein said cost includes a shadow price and/or an opportunity cost.

10. The method of claim 9, wherein said allocating a second portion of said inventory is based, at least in part, on said shadow price.

11. The method of claim 1, wherein said online advertising campaign comprises:
specifying demographics of one or more Internet users;
specifying a quantity of said one or more Internet users; and
specifying a time period for which said online advertising campaign is to target said one or more Internet users.

12. An apparatus comprising:
a computing platform, said computing platform being adapted to:
forecast demand for advertisement inventory directed to an online advertising campaign; and
determine an allocation of advertising inventory using an online process, said determination based, at least in part, on a forecasted future demand for said advertisement inventory.

13. The apparatus of claim 12, wherein said supply forecasting component is adapted to determine demographic, geographic, or behavioral information corresponding to said online advertising campaign, and to forecast said demand by determining a trend using said demographic, geographic, or behavioral information.

14. The apparatus of claim 12, wherein said online advertising campaign comprises:
associated demographics of one or more Internet users;
an associated quantity of said one or more Internet users; and
an associated time period for which said online advertising campaign is to target said one or more Internet users.

15. An article comprising: a storage medium comprising machine-readable instructions stored thereon which, if executed by a computing platform, are adapted to enable said computing platform to:
forecast demand for advertisement inventory directed to an online advertising campaign; and
allocate at least a portion of said advertisement inventory based, at least in part, on a forecasted future demand for said advertisement inventory.

16. The article of claim 15, wherein said machine-readable instructions, if executed by a computing platform, are further adapted to enable said computing platform to:
allocate said at least a portion of said advertisement inventory to said online advertising campaign.

17. The article of claim 15, wherein said machine-readable instructions, if executed by a computing platform, are further adapted to enable said computing platform to:
price said at least a portion of said advertisement inventory based, at least in part, on said forecasted future demand; and
allocate said at least a portion of said advertisement inventory to one or more forecasted advertising campaigns.

18. The article of claim 15, wherein said machine-readable instructions, if executed by a computing platform, are further adapted to enable said computing platform to:
forecast a demand for said advertisement inventory presented by said online advertising campaign, wherein said online advertising campaign comprises a current online advertising campaign.

19. The article of claim 15, wherein said machine-readable instructions, if executed by a computing platform, are further adapted to enable said computing platform to:
determine demographic, geographic, and/or behavioral information corresponding to said online advertising campaign; and
forecast said demand by determining a trend using said demographic, geographic, and/or behavioral information.

20. The article of claim 15, wherein said machine-readable instructions, if executed by a computing platform, are further adapted to enable said computing platform to:
define future online advertising campaigns; and
forecast a demand for said inventory presented by one or more of said future online advertising campaigns.
